(19) United States
(12) Patent Application Publication
(10) Pub. No.: US 2003/0056628 A1
(43) Pub. Date: Mar. 27, 2003

(54) Coaxial spindle cutting saw

(76) Inventor: Eli Razon, Maple Glen, PA (US)

Correspondence Address: John B. Sowell, 182 Midfield Road, Ardmore, PA, 19003-3213, US

(21) Appl. No.: 09/963,604

(22) Filed: Sep. 27, 2001

(51) Int. Cl. B26D 1/00

(52) U.S. Cl. 83/34; 83/35; 83/425.2; 83/471.3

(57) ABSTRACT

A novel cutting saw assembly is provided with coaxial spindles each of which supports a cutting saw blade. One of the coaxial spindles or spindle shafts is moveable in an axial direction relative to each other so as to position two or more cutting saw blades accurately spaced apart from each other. The two cutting saw blades are dressed to the same diameter and are moveable close together when in operation so that both saw blades can make complete cuts simultaneously on the same wafer, thus increasing the throughput of the cutting saw by almost 100 percent.

### BACKGROUND OF THE INVENTION

1. Field of the Invention

The present invention relates to high-speed precision cutting saws for dicing semiconductor wafers and/or singulating devices from a substrate or printed circuit board. More particularly, the present invention provides a novel coaxial spindle cutting saw using multiple cutting blades driven by a single spindle drive motor.

2. Description of the Prior Art

Heretofore, saws for cutting semiconductor wafers were known. Dicing saws are classified in U.S. Class 125 under several subclasses. Cutting saws for dicing silicon wafers usually employ thin flexible blades made from electro-deposited nickel having a fine powder of diamond particles embedded in the dicing saw blades. Such blades are made as annular rings and/or deposited directly onto a mounting flange or hub-like structure and are known as hub blades. Dicing saw blades can be made in thicknesses from about 1/1000^{th} of an inch to over 10/1000^{th} of an inch and are employed to remove the thin semiconductor street material that separates individual die on a wafer. The thin cut minimizes the material removed and maximizes the number of die produced on a given size wafer. Sometimes it is preferred to use two separate passes in cutting the same street on a wafer to reduce chipping and to maximize yields.

Singulation saws are used for cutting and separating packaged semiconductor devices that are already mounted on Printed Circuit (PC) boards or other forms of strips and substrates and may employ relatively thick dicing saw-type blades. Singulation saw blades are also made in the form of a homogeneous mixture of diamonds held in place by a binding material such as epoxy resins and are referred to as diamond impregnated resinoid saw blades and have been used for dicing semiconductor related materials. The preferred shape of the relatively thick resinoid saw blades is made in the form of an annular ring and clamped and held by inner and outer flanges of a hub. Such saw blades are known as hubless blades.

Both types of saw blades have been used on cutting saws having single or dual spindles. Dual spindle cutting saws are used to increase the yield of devices cut by simultaneously cutting paths or streets on the same wafer or device so as to decrease the time for processing a wafer or strip or substrate, etc.

As will be explained in greater detail hereinafter, two forms of dual spindle cutting saws are presently used in the semiconductor industry. Both forms of dual spindle cutting saws used in the prior art employed two identical cutting saw heads that are positioned side-by-side for cutting the same street twice or staggered in the Y direction to permit cutting two different streets in a single pass.

Heretofore, dual spindle and twin spindle cutting saws duplicated the cutting saw heads and gantries but employed the same work station and X axis system to improve efficiency of the cutting saw from about 50 to 75 percent. Accordingly, it would be desirable to provide a novel cutting saw which eliminates duplication of heads and gantries yet provides a smaller machine size footprint and provides close to 100 percent greater throughput over a single spindle cutting saw at negligible increase in cost.

### SUMMARY OF THE INVENTION

It is a principal object of the present invention to provide a novel coaxial spindle cutting saw for driving multiple cutting saw blades.

It is a principal object of the present invention to provide a single spindle drive motor for a coaxial spindle cutting saw having multiple cutting blades.

It is a principal object of the present invention to provide a novel coaxial spindle for a cutting saw having means for programming the distance between saw blades from approximately zero up to around five inches.

It is a principal object of the present invention to provide novel hubs and hub adapters for mounting saw blades substantially abutting each other or spaced apart by a predetermined amount.

It is a principal object of the present invention to provide up to three cutting saw blades on a single coaxial spindle, thus, maintaining a small machine footprint requirement substantially the same as a single spindle cutting saw in a multiple blade cutting saw.

It is a principal object of the present invention to provide a multiple blade cutting saw that increases the output of sawn wafers over prior art single spindle cutting saws by the ratio of the number of blades on the coaxial spindle.

It is a principal object of the present invention to provide a novel single coaxial spindle cutting saw that can double production of a single blade cutting saw of the prior art type at a cost that is very close to a prior art single spindle cutting saw.

It is a principal object of the present invention to provide a multiple blade cutting saw that has higher throughput at lower cost than prior art cutting saws.

According to these and other objects of the present invention there is a provided in a dicing saw/singulation saw a housing for supporting a single coaxial spindle and drive motor. The coaxial spindle is adapted to support up to three hubs each of which provides a cutting saw blade operating at the same rotational speed as the other blades. Further there is provided positioning means mounted on the housing which is adapted to position the blades relative to each other in a parallel array which enables the multiple blades to simultaneously cut parallel streets or paths through a wafer or surface mounted (SMT) device in a single pass.

### BRIEF DESCRIPTION OF THE DRAWINGS

FIG. 1 is an isometric view of a prior art twin wafer dicing saw having two housings, two spindles, and two cutting blades arranged as reflected twin images of each other;

FIG. 2A is a schematic view in front elevation showing the gantry system for moving the cutting saw blades in FIG. 1 in X, Y and Z directions;

FIG. 2B is a schematic view in front elevation of side-by-side or dual cutting saws showing a different gantry arrangement for achieving X, Y and Z direction motions;

FIG. 3 is a schematic view in front elevation of the present invention coaxial spindle cutting saw showing a single housing and two cutting saw blades operable simultaneously from a single gantry,

FIG. 4 is an isometric drawing of a preferred embodiment of the present invention coaxial spindle cutting saw showing schematic the drive motor and positioning motors for the spindles and spindle supports;

FIG. 5A is a schematic side or front elevation of the present invention coaxial spindle singulation or dicing saw showing two blades mounted on the coaxial spindles with the rear saw blade moveable in a Y′ direction by a voice coil motor;

FIG. 5B is an enlarged detail of the cutting saw of FIG. 5A showing air bearings and seals with the rear saw blade is moveable in a Y′ direction by a voice coil;

FIG. 6 is a modification of the cutting saw shown in FIGS. 4 to 5B in front or side elevation showing a moveable front saw blade and linear or voice coil drive motor for positioning the moveable front saw blade;

FIG. 7 is an enlarged detail of a modified cutting saw in front or side elevation showing the front or outboard saw blade moveable in the Y′ direction by a voice coil mounted on the spindle housing;

FIG. 8 is an exploded view in elevation and section of two hub-type saw blades, one of which employs an adapter for mounting on dual or twin-type spindles for achieving a minimum space between cutting saw blades; and

FIG. 9 is an elevation view in section of a flange-type hub for clamping an annular ring-type saw blade between two flanges.

### DESCRIPTION OF THE PREFERRED EMBODIMENTS

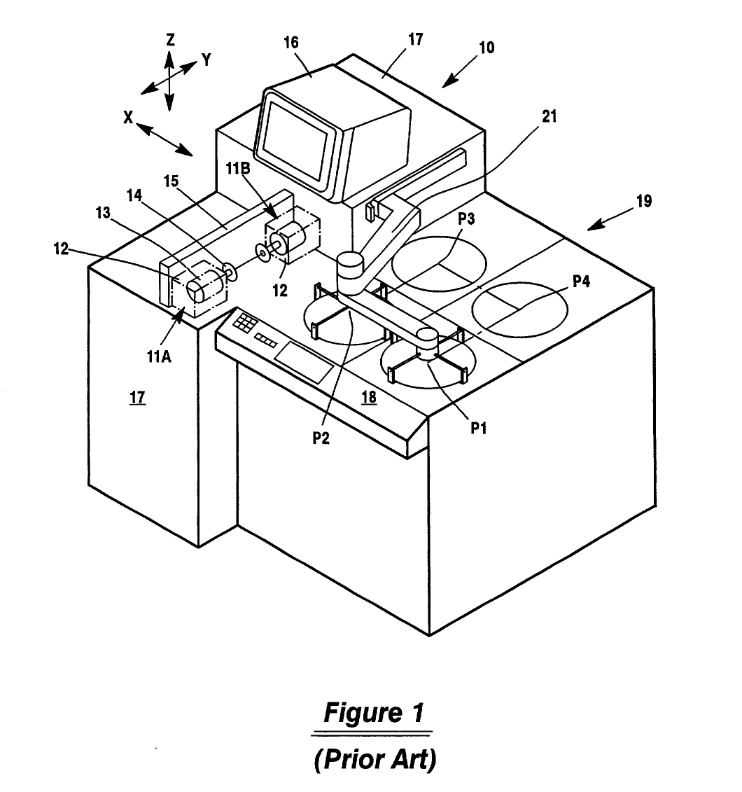

Refer now to FIG. 1 showing an isometric view of a prior art wafer dicing saw 10 having two cutting saw heads 11A and 11B each comprising a housing 12, a drive motor 13 and a cutting saw blade 14. The housing 12 is shown mounted for Y-Z support movement on the Y-Z gantry 15. It will be understand that below the saw blades 15 there will be a workstation supporting a wafer or device to be sawn. Cutting saw 10 further comprises a monitor 16 mounted on cabinet 17 which includes therein controls (not shown). The control keyboard 18 is shown mounted on the wafer handling system 19 but could have been mounted on cabinet 17. The wafer handling system 19 is shown having four stations P1 to P4. P1 is the docking station from which new wafers are taken by the robotic arm 21 and transferred to the loading station P2. After being sawn the robotic arm 21 simultaneously transfers a new wafer from P1 to P2 and the sawn wafer from P2 to the cleaning station P3. After cleaning the sawn wafer is transferred to the elevator or loading station p4 which will take it down into the system where the magazines are located.

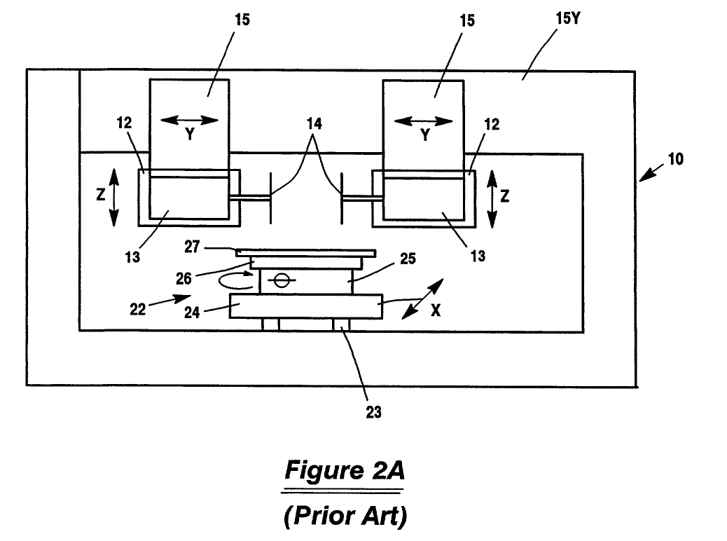

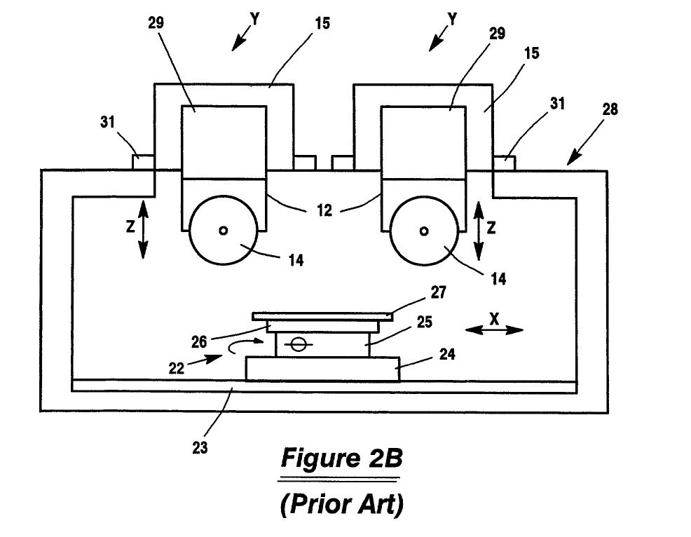

Refer now to FIG. 2A showing a schematic view of the cutting saw 10 described in FIG. 1. The numerals in FIG. 1 that are similar or identical to the structure in FIG. 2 are the same and do not require additional explanation. It will be noted that the Y-Z support gantry 15 acts as a slider in the Y direction and supports the housing 12 which supports the motor 13 which supports the cutting blades 14. Thus the motor 13 and blades 14 are moveable vertically in the Z direction on support 15 and are also moveable in the Y direction on the Y support shown as 15Y of cutting saw 10.

Mounted on the cutting saw 10 there is shown a pair of X rails 23 which support an X slider 24 which supports a theta access table 25 which supports the chuck 26 on which the wafer/wafer frame 27 is mounted. Thus it will be understood that blades 14 may be lowered into engagement with the wafer 27 and the wafer moved in the X direction by the control system not shown. The cutting saw 10 described in FIGS. 1 and 2A is also described in U.S. Pat. No. 5,842,461 and is known as a twin spindle cutting saw.

Refer now to FIG. 2B showing a schematic view in front or side elevation of a dual cutting saw 28 of the type shown and described in U.S. Pat. No. 4,688,540. The side-by-side cutting heads which comprise housings 12 for supporting the drive motors (not shown) which support the cutting saw blades 14 are moveable in the Z direction on the Y-Z supports 15 which are moveable in the Y direction on the Y rails 31. The housings 12 are further moveable with the Z slider 29 to engage the cutting blades 14 with the wafer 27 or substrate mounted on the chuck 26. It will be understood that the side-by-side arrangement of the cutting blades mitigates against simultaneous cutting operation on a wafer 27. Thus the improvement over a single spindle cutting saw is in the area of 40 to 50 percent greater throughput, whereas, the twin cutting saw shown in FIG. 2A has an improvement factor over a single spindle cutting saw of 70 to 80 percent depending on the size of the wafer. The workstation 22 is similar or identical to the workstation described in FIG. 2A and employs the same numerals and mode of operation as described hereinbefore.

While the efficiency of the cutting saw 28 shown in FIG. 2B is lower than the cutting saw shown in FIGS. 1 and 2A, it has the advantage that the cutting saw blades 14 are easily accessible to replace blades and one saw blade may be used to cut a V groove partially through a wafer or substrate and the second blade can be used to cut completely through on the same cut in the same street which reduces chipping.

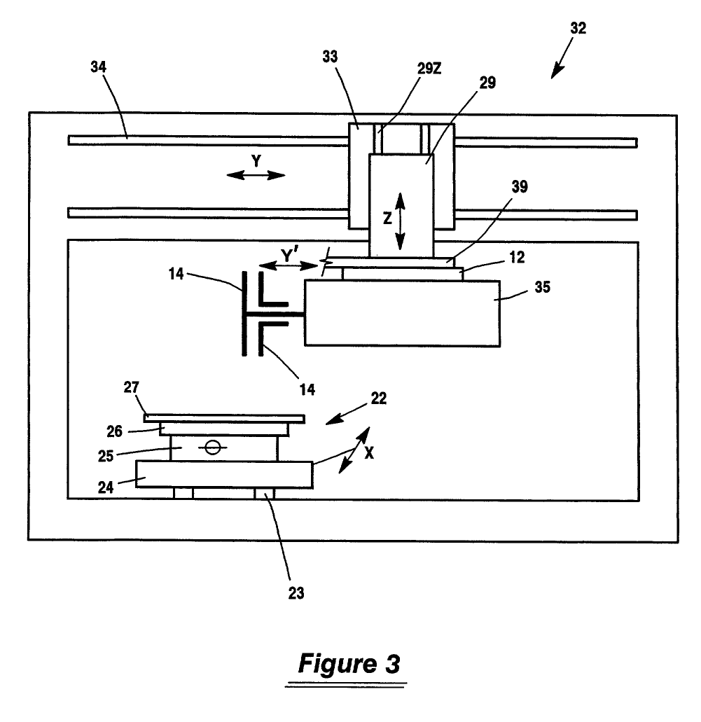

Refer now to FIG. 3 showing a schematic view in front or side elevation of the present invention coaxial spindle cutting saw. The Z slider 29 is coupled to the housing 12 for supporting the novel spindle/spindle housing 35 and is moveable in the Z direction on Z rails 29Z. The Y slider 33 is moveable on the Y rails 34 for a gross or a major movement of the spindle/spindle housing 35. As will be explained in detail hereinafter, one of the two cutting blades 14 is moveable relative to the other cutting blade in the Y prime (Y′) direction. The workstation 22 shown below the cutting blades 14 is moveable on the X rails 23 and is substantially the same as the workstation described in FIG. 2 hereinbefore. While simultaneously cutting a wafer 27, it may be possible for one of the two blades 14 to wear more or less than the other cutting blade. In this event the cutting blade with the most wear is arranged to cut in a street previously cut by the other saw blade until the two blades again reach the same diameter. Prior art methods may be employed to occasionally check the diameters of the blades to employ a correction cut or two until the two blades are the same diameter.

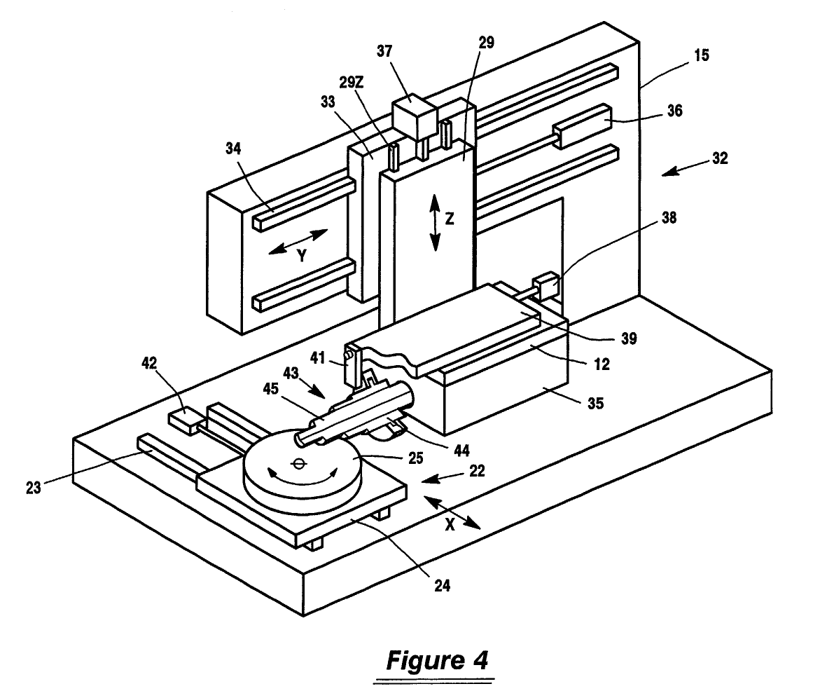

Refer now to FIG. 4 showing an isometric drawing of a preferred embodiment of the present invention coaxial two-spindle cutting saw 32. The Y-Z support or gantry 15 is shown having a Y slider 33 mounted for movement on the Y rails 34. A Z slider 29 is shown mounted on Z rails 29Z which are supported by the Y slider 33. There is shown a Y drive 36 for moving the Y slider 33. The Z slider 29 is shown supporting the housing 12 which supports the spindle housing 35 and has a Y prime slider 39 mounted thereon and moved by a Y prime drive 38. The Y prime slider 39 is shown having an actuating arm 41 which will be described in greater detail hereinafter for providing the Y prime movement to the outer moveable shaft 44 of the coaxial spindle which comprises a center shaft 45.

The workstation 22 comprises an X slider 24 slideably mounted on the X rails 23 and moved by the X drive 42. In this view, the chuck and wafer and wafer frame and the blades are not shown so as to describe the details of the coaxial shaft 43 which will be described in greater detail hereinafter.

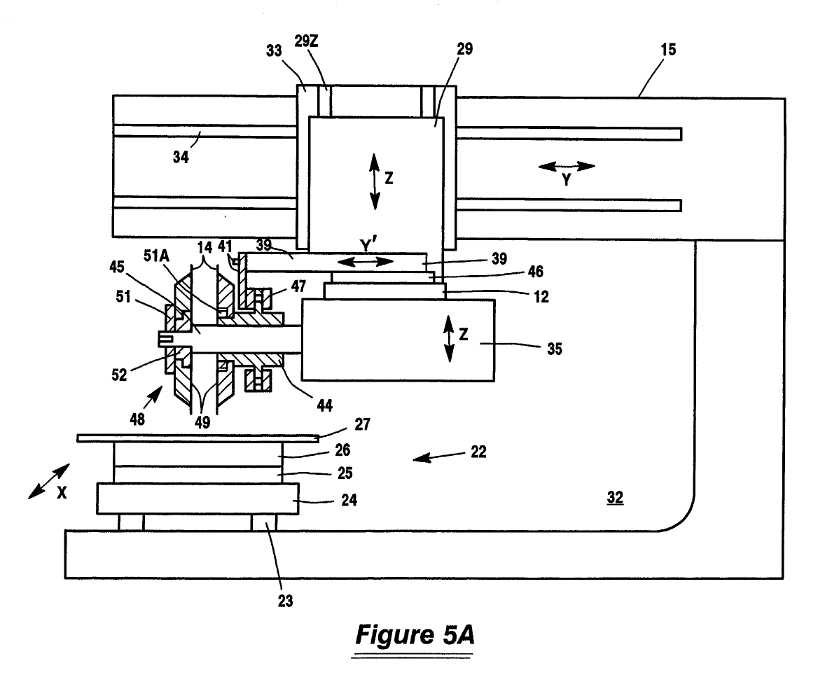

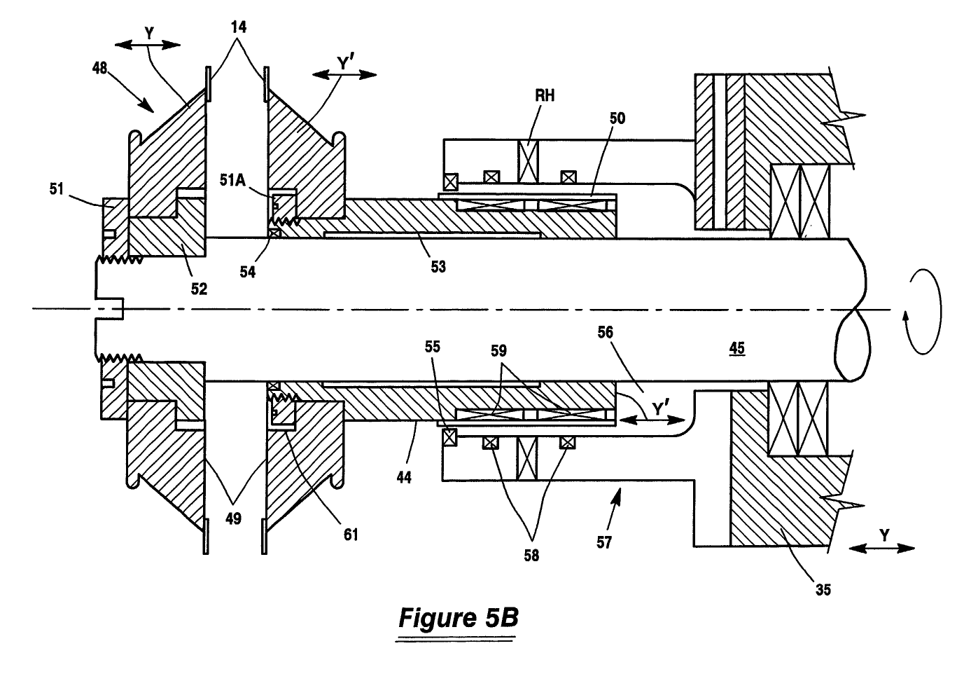

Refer now to FIG. 5A showing a schematic drawing in front or side elevation of the present invention coaxial spindle 44, 45 for use in the dicing saws previously shown and described.

FIG. 5A shows further details of the cutting saw of the type shown in FIG. 4 wherein the rear saw or inbound blade 14 is moveable and positionable by a slider 39. The Y-Z gantry 15 is shown supporting a Z slider 29 on the Z rails 29Z for movement in the vertical direction. The Z slider 29 supports a spindle housing 12 which supports a Y prime rail 46 on which is mounted a Y prime slider 39. The Y prime slider 39 supports an actuator arm 41 which in turn supports an air bearing coupling 49. It will be understood that the outer shaft 44 is preferably supported on an air bearing for slideable movement on the center shaft 45 and the coupling 47 also includes an air bearing which couples to the outer annular ring on the outer shaft 44. It will be understood that the slider 39 is programmed to move the outer shaft 44 which supports the inner hub 48 which comprises a blade portion 14. Thus, it will be understood that the inner blade 14 can be moved to flush engagement with the outer blade 14 so as to cut a wide street or accurately position so as to cut two adjacent streets on either side of a semiconductor device.

The hub-type blade 48 is basically a modification of prior art single piece hub-type blades and comprises a flat face hub portion 49, a lock nut portion 51. The adapter portion 52 permits the lock nut 51 to be flush mounted in against the flat face hub portion 49 so that the hubtype blades can be positioned flush to each other.

Refer now to FIG. 5B showing an enlarged drawing in side or front elevation of the present invention coaxial dual spindle cutting saw showing two hub-type blades mounted on the coaxial spindles or shafts 44 and 45 with the rear or inboard saw blade 14 moveable by a voice coil assembly 57. There is shown a spindle housing 35 which is moveable in the Y direction and supports the frame of the voice coil assembly 57 which supports therein the electrical actuating coils 58. The coils 58 drive the outer moveable shaft 44 which supports the permanent magnets 59 in the flux field of the actuating coils 58. Shown schematically at 53 is a spine or keyed system which allows linear motion but not relative rotational motion to the center shaft 45. It will be understood that regardless of the type of key or spine that is used, the outer moveable shaft 44 is preferably supported on an air bearing especially for high speed. However, the outer moveable shaft 44 could be supported on conventional bearings especially for low speed or singulation. Further, there is provided a water seal 54 and a water seal 55 to prevent cooling water from entering the system. A pressurized air chamber 56 may be provided to maintain an air flow at the seal 55 to guarantee that no water enters into the moving system.

It is understood that the voice coil assembly 57 moves in the Y direction with spindle housing 35 and has a Y prime linear movement as a result of the voice coil assembly moving the outer shaft 44 relative to the outer blade. Thus, it can be seen that the blade portion 14 of the modified hub 48 is capable of being moved into flush contact with each other. Further, the locking nut 51A on the inner hub is recessed in an annular recess 61 so that the flat flange face 49 is capable of moving into abutting relationship with other saw blade. The modified hub 48 is shown having a larger outer locking nut 51 and an adapter 52. In the preferred embodiment of the present invention the voice coil assembly 57 may be accurately positioned with an encoder 50 or a laser interferometer device RH as is known in the prior art.

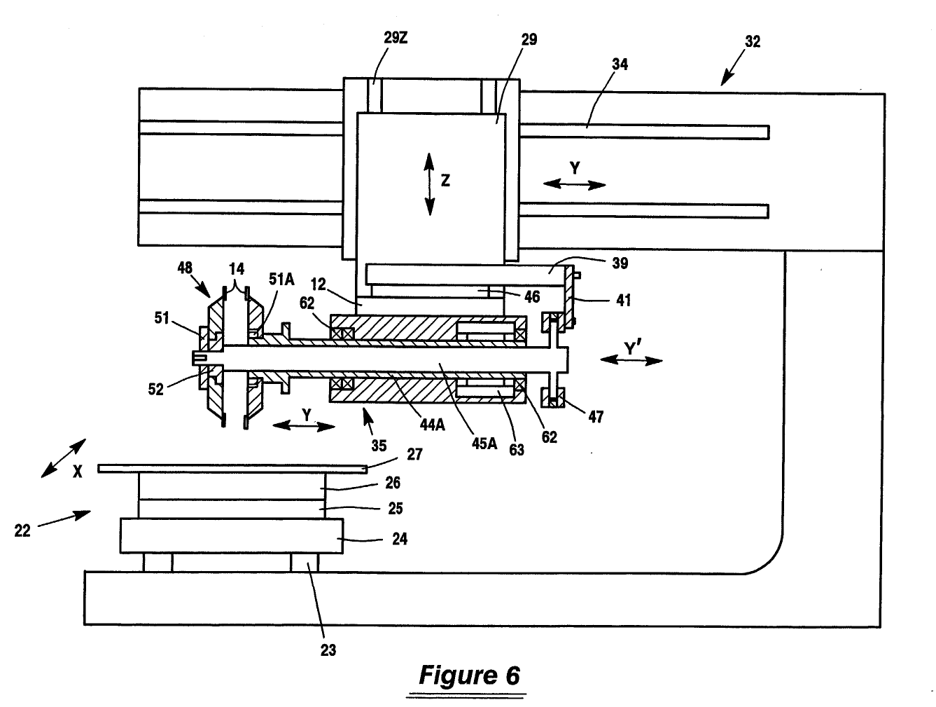

Refer now to FIG. 6 showing a modification of the cutting saw shown in FIG. 5A and having a front saw blade 48 that is moveable by an actuating arm 41 mounted on a slider 39 on the rear of the spindle housing 12. The numerals for the work station and the gantry and Z sliders are the same as those shown in previous drawings and do not require additional explanation. There is shown mounted on the housing 12 a Y prime rail 46 on which is mounted a Y prime slider 39 which supports an actuating arm 41 which supports the air bearing coupling 47. In this embodiment the center shaft 45A is modified to extend completely through the spindle housing 35 and supports the outer saw blade assembly 48 which is moveable relative to the inner saw blade shown mounted on the outer fixed shaft 44A which is rotationally fixed to the shaft 45A. Further, there is shown spindle air bearings at both ends of the spindle housing 35 which supports the outer shaft 44A. Further there is shown a spindle motor 63 which is coupled to drive the outer shaft 44A. As explained hereinbefore, the outer shaft 44A is coupled to the inner shaft 45A by either a spline or a key.

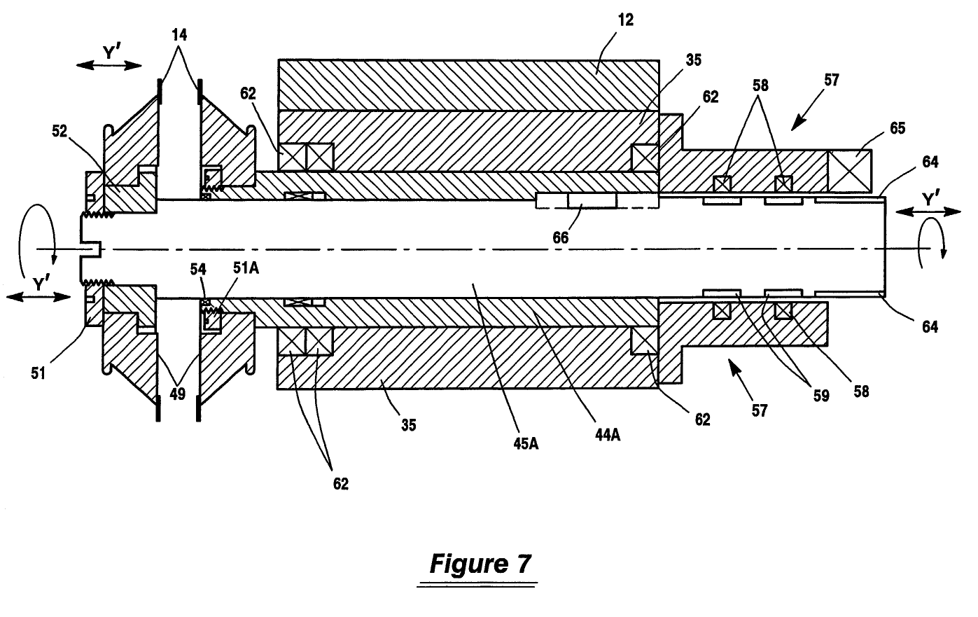

Refer now to FIG. 7 showing a voice coil assembly 57 mounted on the rear portion of the spindle housing 35. In this embodiment the coils 58 cooperate with the permanent magnets 59 to move the permanent magnets 59 which in turn move the inner shaft 45A axially relative to the outer shaft 44A so that the outer hub 48 moves relative to the inner hub and inner blade 14. There is shown a key 66 which is carried by the outer shaft which engages the inner shaft so as to rotate the shafts 44A and 45 together and still allow a linear or axial movement relative thereto. This is the fine or Y prime movement of the outer hub 48. Further, there is shown an encode scale 64 mounted on the inner shaft 45A whose position is determined by the sensor 65 mounted on the voice coil assembly housing 57. The numerals in FIG. 7 that are the same as those shown in previous drawings are similar in structure and mode of operation and do not require an additional explanation. There is an advantage to having the voice coil assembly at the rear of the spindle housing 35 in that it is remote from the cutting blades where the source of cooling water may enter into the actuating system.

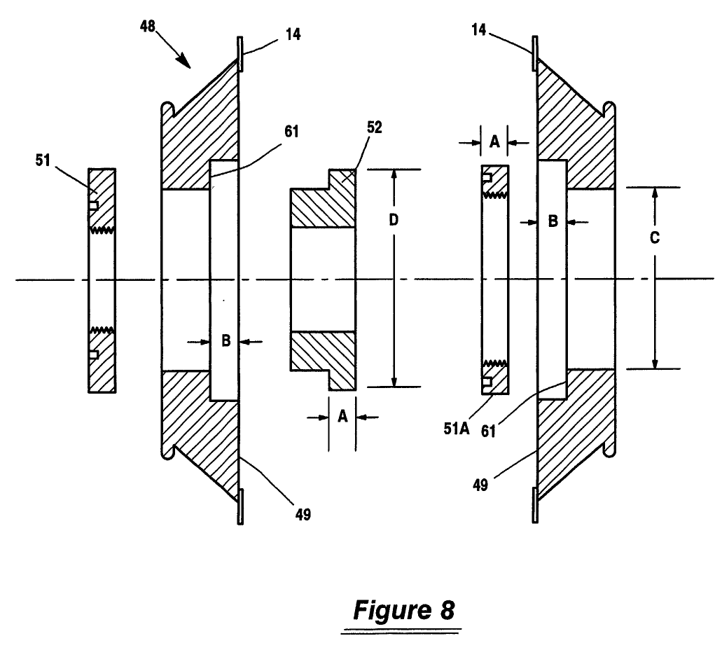

Refer now to FIG. 8 showing an exploding view of a preferred embodiment multi-piece hub 48 and a conventional hub which is modified to provide a feature to be explained hereinafter. The hub 48 comprises a hub portion with a flat face 49 on which the blade portion 14 is deposited as known in the prior art. The hub portion also comprises a recess 61 which in the leftmost hub permits the adapter 52 to fit flush or recessed into the hub. Flange A is preferably thinner than the recess shown at B. The leftmost locking nut 51A locks onto the center shaft 45A or 45 as the case may be. The rightmost hub is shown having an inner diameter C which seats onto the outer shaft 44 or 44A. Further, the locking nut 51A is shown being thinner at thickness A than the depth of the recess 61 shown at B. This permits the inner flat faces 49 of the hubs 48 to be positioned flush against each other so that the blade portions 14 may absolutely touch. While the purpose of the modified and improved hub is to enhance the ability of the present invention cutting saw to make cuts on adjacent street of small die, the same modified hubs may be used in prior art cutting saws of the type similar to that shown in FIGS. 1 and 2A.

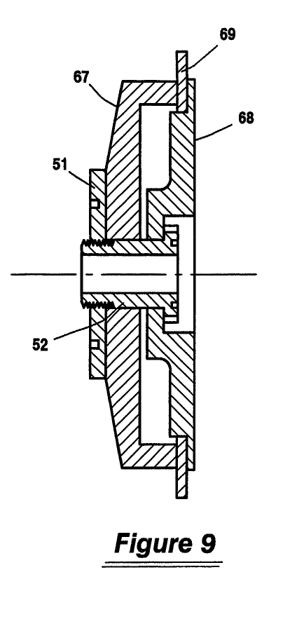

Refer now to FIG. 9 showing an elevation in section of a flange-type hub for clamping an annular ring-type saw blade between two flanges. In this embodiment the outer lock nut 51 screws onto the adapter 52 and holds the outer flange 67 in contact with the inner flange 68 which supports the annular ring-type blade 69. Blades of the type shown in FIG. 9 are often referred to as hubless and are so named because the annular blade 69 is not a part of a hub but is supported by a two-piece hub.

Having explained a preferred embodiment an several modifications of the present invention novel cutting saw using coaxial spindle shafts it will be understood that further modification may be made by including a third spindle shaft which is a combination of the two spindles shown hereinbefore. The most important feature of the present invention is that it provides substantially 100 percent greater throughput and output over a single spindle and single blade cutting saw as known in the prior art. The two major dual and twin spindle cutting saws have been explained with reference to FIGS. 1 and 2B and neither of these saws will provide an improved output over a single spindle greater than about 70 percent.

Further, it will be appreciated that the present invention coaxial spindle cutting saw has only one gantry, one set of rails and one spindle housing so that it completely eliminates the need for an extra Y-Z gantry system, extra spindle housing and drive motor. Stated differently, the present invention can be manufactured for slightly more than a single spindle saw and only has the footprint of a single spindle saw yet produces twice the output of a single spindle saw.

Further it will now be appreciated that the present invention coaxial spindle cutting saw housing and assembly may be retrofitted into saws of the type shown in FIGS. 1 to 2B as well as in single spindle saw environments.

What is claimed is:

1. A coaxial spindle cutting saw for dicing wafers and singulating substrates, comprising:
a spindle housing for mounting on a cutting saw;
a coaxial spindle mounted in said spindle housing for movement therewith,
said coaxial spindle comprising a center spindle having first mounting means for positioning a first cutting saw blade mounted on said center spindle,
said coaxial spindle further comprising an outer hollow spindle mounted on said center spindle for rotation therewith and for axial movement relative thereto,
second mounting means for positioning a second cutting saw blade on said outer hollow spindle,
a spindle drive motor coupled to said spindles for rotating both said center spindle and said outer hollow spindle together at the same rotational speed; and
spindle positioning means coupled to one of said spindles for accurately positioning one of said cutting saw blades relative to the other cutting saw blade.

2. A coaxial spindle cutting saw as set forth in claim 1 which further includes a second spindle housing mounted on said same cutting saw; and
four spindles in said two spindle housings for mounting four cutting saw blades for simultaneously cutting operations.

3. A coaxial spindle cutting saw as set forth in claim 2 wherein said spindle housings are mounted with their spindle axes mounted side-by-side and independently moveable in Y and Z axes.

4. A coaxial spindle cutting saw as set forth in claim 2 wherein said spindle housings are mounted end-to-end in substantially the same axis and independently moveable in Y and Z axes.

5. A coaxial spindle cutting saw as set forth in claim 1 wherein said outer hollow spindle further includes an air bearing surface between an inner diameter of the outer hollow spindle and an outer diameter of the center spindle.

6. A coaxial spindle cutting saw as set forth in claim 5 wherein said outer hollow spindle further includes an air-bearing surface on the outer diameter of said outer hollow spindle.

7. A coaxial spindle cutting saw as set forth in claim 6 wherein said positioning motor means further includes a voice coil actuating means mounted on said spindle housing for positioning said outer spindle relative to said center spindle.

8. A coaxial spindle cutting saw as set forth in claim 6 wherein said actuating means further includes a moveable actuating arm slideable relative to said spindle housing; and
an air-bearing coupling mounted on said actuating arm for movement of said outer spindle.

9. A coaxial spindle cutting saw as set forth in claim 6 wherein said positioning motor means further includes a moveable actuating arm mounted on said spindle housing; and
coupling means mounted on said actuating arm for movement of said outer spindle.

10. A coaxial spindle cutting saw as set forth in claim 1 wherein said spindle drive motor is directly coupled to one of said coaxial spindles.

11. A coaxial spindle cutting saw as set forth in claim 1 wherein said spindle drive motor is mounted in or on said spindle housing.

12. A method of making two saw cuts simultaneously, comprising the steps of:
mounting a spindle housing on said cutting saw for Y and Z movement relative to a work station,
mounting an outer spindle slideably mounted relative to an inner spindle in said spindle housing to provide a pair of coaxial spindles,
providing a spindle drive motor for rotating said inner spindle and said outer spindle together in the same spindle housing,
mounting a first cutting saw blade on said inner spindle and a second cutting saw blade on said outer spindle, and
positioning one of said saw blades relative to the other saw blade by moving one of said coaxial spindles relative to the other to position said cutting saw blades juxtaposed each other for simultaneously cutting the same work piece on the workstation.

13. The method as set forth in claim 12 wherein the step of positioning one of said saw blades relative to the other comprises:
providing a voice coil actuator on said spindle housing, and
positioning said outer spindle on said inner spindle by actuating said voice coil of said voice coil actuator.

14. The method as set forth in claim 12 wherein the step of positioning further comprises providing an encoder scale on one of said spindles, and
sensing the position of said encoder scale to position the moving spindle.

15. The method as set forth in claim 12 wherein the step of positioning further comprises providing an encoder sensor scale on an actuating arm of said spindle housing and sensing the position of the encoder scale to position the moving spindle.

16. A multi-piece hub for dual twin and coaxial spindle cutting saws where the spindles have positioning shoulders for receiving a hub, comprising:
a hub portion for mounting on said positioning shoulders,
said hub portion having a flat disc-like flange portion for receiving a cutting saw blade on a radially outer annular surface,
an annular recess in said flat flange portion,
a flat annular receiving portion in the bottom of said annular recess, and
lock nut means for fitting in said annular recess below said flat disc-like flange portion and for mounting on a spindle, whereby two said hubs on two of said spindles may be mounted with their flat disc-like flange portions flush against each other.

17. A multi-piece hub as set forth in claim 16 wherein said hub comprises an inner flange portion and an outer flange portion for clamping an annular cutting saw blade there between,
said locking means comprises an adapter bushing for fitting into said annular recess, and
said lock nut means for holding said inner and said outer flanges together on a spindle.

18. A multi-piece hub as set forth in claim 16 wherein said lock nut means comprises a locking nut for fitting into the annular recess and for holding said hub onto one of said spindles.

19. A multi-piece hub as set forth in claim 16 wherein said locking means comprises a locking nut adapter for fitting into the annular recess and a locking nut for holding said hub onto one of said spindles.
